(19) United States
(12) Patent Application Publication
(10) Pub. No.: US 2004/0135663 A1
(43) Pub. Date: Jul. 15, 2004

(54) PTC thermistor having safety structure for preventing continuous breakage

(76) Inventor: Byong-Jun Jang, Cheongju-si (KR)

Correspondence Address: Galgano & Burke, Suite 35, 300 Rabro Drive, Hauppauge, NY, 11788, US

(21) Appl. No.: 10/675,131

(22) Filed: Sep. 30, 2003

(30) Foreign Application Priority Data
Jan. 13, 2003 (KR) 2003-2209

(51) Int. Cl. H01C 7/10

(52) U.S. Cl. 338/22 R

(57) ABSTRACT

Disclosed herein is the present invention provides a PTC thermistor having a safety structure for preventing continuous breakage. The PTC thermistor includes a casing, a PTC element, an insulation holder, two conductive tap terminals, two spring terminals, and a cap. The PTC element is provided with electrodes formed by coating both sides of a coin-shaped body formed of barium titanate ceramic as a chief ingredient with a conducting material, such as silver. The conductive tap terminals are accommodated in the casing. The spring terminals are each connected to the tap terminals, each bent symmetrically and oppositely, and each brought into contact with the electrodes of the PTC element with the PTC element being disposed therebetween. A weak portion is formed in a portion of each of the spring terminals connected to the tap terminals so as both to allow a current to be applied to the PTC element while connecting with the PTC element and to act as a fuse that is cut off at the time of the inflow of an overcurrent.

### BACKGROUND OF THE INVENTION

1. Field of the Invention

The present invention relates generally to a positive temperature coefficient thermistor having a safety structure for preventing continuous breakage, which is a non-contact starting relay mounted on the compressor of a refrigerator or an air conditioner to start the compressor. More specifically, the present invention relates to a positive temperature coefficient thermistor having a safety structure for preventing continuous breakage, in which tap terminals connected to the outside and spring terminals mechanically connected to the tap terminals are mechanically and electrically connected to a positive temperature coefficient element, and an electrically weak portion of a size in the range of 0.1 mm˜0.8 mm is formed in a portion of each of the spring terminals connecting the tap terminals to the positive temperature coefficient element, so that a stable current flows in the weak portion if a normal operating current flows in the PTC thermistor, whereas the weak portion is cut off while acting as a fuse because a current in excess of an allowable current is generated in the weak portion if the positive temperature coefficient element is broken by the thermal stress of the positive temperature coefficient element or an overcurrent caused by external abnormal power flows in the PTC thermistor, resulting in the fact that the continuous breakage of the positive temperature coefficient element is no longer generated by preventing the flow of current because a short-circuit overcurrent generated at the time of the breakage of the positive temperature coefficient element or an overcurrent flowing into the PTC thermistor from the outside is interrupted in an electric circuit due to the cutting off of the weak portion, thus preventing the generation of contaminants or a fire resulting from the continuous breakage of the positive temperature coefficient element, and, therefore, both improving the total efficiency of a product and maximizing the reliability of the product.

2. Description of the Related Art

In general, when a Positive Temperature Coefficient (PTC) thermistor, which is a non-contact starting relay, is mounted on the compressor of a refrigerator or an air conditioner and functions to start the compressor, the PTC thermistor is broken by an abnormal voltage or current provided from the outside, or by thermal stress. At this time, continuous breakage, such as second and third breakage, is generated due to the continuous inflow of the current, so that an insulation casing surrounding a PTC element is melted at the same time that the PTC element is completely burned, thus producing contaminants and causing a fire.

Accordingly, a conventional PTC thermistor for starting motor is broken by thermal stress or an abnormal voltage, and second and third breakage occurs due to the continuous application of power. In this case, since a PTC element is electrically connected to terminals facing each other at both ends of the PTC element, the PTC element is completely broken.

Safety structures used in a prior art to prevent continuous breakage are disclosed in Korean Unexamined Pat. Appl. Pub. No. 1997-77379, Korean Unexamined Utility Model Appl. Pub. No. 1998-26187 and Korean Unexamined Pat. Appl. Pub. No. 2001-29532. Such safety structures are designed to mechanically prevent breakage using the symmetry of terminals. However, these safety structures are problematic in that the performance of the safety structures is degraded due to the irregular breakage of the PTC thermistors and the operating times of the safety structures are delayed.

Accordingly, the efficiency of the prior art safety structures is degraded due to those problems, so that the reliabilities of products using the safety structures are deteriorated.

### SUMMARY OF THE INVENTION

Accordingly, the present invention has been made keeping in mind the above problems occurring in the prior art, and an object of the present invention is to provide a PTC thermistor having a safety structure for preventing continuous breakage, in which tap terminals connected to the outside and spring terminals mechanically connected to the tap terminals are mechanically and electrically connected to a PTC element, and an electrically weak portion of a size in the range of 0.1 mm˜0.8 mm is formed in a portion of each of the spring terminals connecting the tap terminals to the PTC element, so that a stable current flows in the weak portion if a normal operating current flows in the PTC thermistor, whereas the weak portion is cut off while acting as a fuse because a current in excess of an allowable current is generated in the weak portion if the PTC element is broken by the thermal stress of the PTC element or an overcurrent caused by an external abnormal power source flows in the PTC thermistor.

Another object of the present invention is to provide a PTC thermistor having a safety structure for preventing continuous breakage, in which the continuous breakage of the PTC element is no longer generate by preventing the flow of current because a short-circuit overcurrent generated at the time of the breakage of the PTC element or an overcurrent flowing into the PTC thermistor from the outside is interrupted in an electric circuit due to the cutting off of the weak portion.

Another object of the present invention is to provide a PTC thermistor having a safety structure for preventing continuous breakage, in which the generation of contaminants or a fire resulting from the continuous breakage of the PTC element is prevented, thus improving the total efficiency of a product and maximizing the reliability of the product.

In order to accomplish the above object, the present invention provides a PTC thermistor having a safety structure for preventing continuous breakage, including a casing made of a heat-resistant, insulating and nonflammable material; a PTC element provided with electrodes formed by coating both sides of a coin-shaped body formed of barium titanate ceramic as a chief ingredient with a conducting material, such as silver; an insulation holder adapted to fixedly hold the PTC element so that the PTC element is stably accommodated in an inner space of the casing; two conductive tap terminals accommodated in the casing; two spring terminals each connected to the tap terminals, each bent symmetrically and oppositely and each brought into contact with the electrodes of the PTC element with the PTC element being disposed therebetween; and a cap provided with holes formed at positions brought into contact with the tap terminals, and two insulation walls extended from a bottom of the cap; wherein a weak portion is formed in a portion of each of the spring terminals connected to the tap terminals so as both to allow a current to be applied to the PTC element while connecting with the PTC element and to act as a fuse that is cut off at the time of the inflow of an overcurrent.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing the appearance of a PTC thermistor to which the present invention is applied;

FIG. 2 is an exploded perspective view of the PTC thermistor of FIG. 1;

FIG. 3 is a perspective view of an example in which spring and tap terminals is connected to each other in accordance with an embodiment of the present invention;

FIGS. 4A to 4C are enlarged views of weak portions in accordance with other embodiments of the present invention;

FIG. 5 is a view of a weak portion formed in another portion of the spring terminal in accordance with another embodiment of the present invention;

FIGS. 6A and 6B are views of conventional spring and tap terminals broken by the inflow of high current at the time of the breakage of PTC elements; and

FIG. 7 is a view of the spring and tap terminals of the present invention broken by the inflow of high current at the time of the breakage of PTC elements;

FIG. 8 is a graph illustrating the relation between an applied current and the operating time of a PTC element, according to the present invention; and

FIG. 9 is a graph showing cut-off times of the weak portion acting as a fuse according to the application of currents.

### DESCRIPTION OF THE PREFERRED EMBODIMENTS

Reference now should be made to the drawings, in which the same reference numerals are used throughout the different drawings to designate the same or similar components.

Hereinafter, the present invention will be described in detail with reference the accompanying drawings.

In describing the present invention below, if it is determined that detailed descriptions of a prior art and construction would make the subject matter of the present invention unclear, the detailed descriptions will be omitted.

Since terms to be mentioned later refer to terms determined in consideration of the functions of the present invention and can be changed according to the intention of manufacturers or usual practices, the definitions of the terms should be given based on the overall specification.

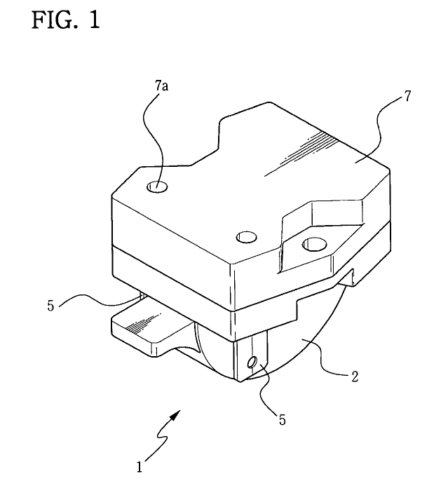

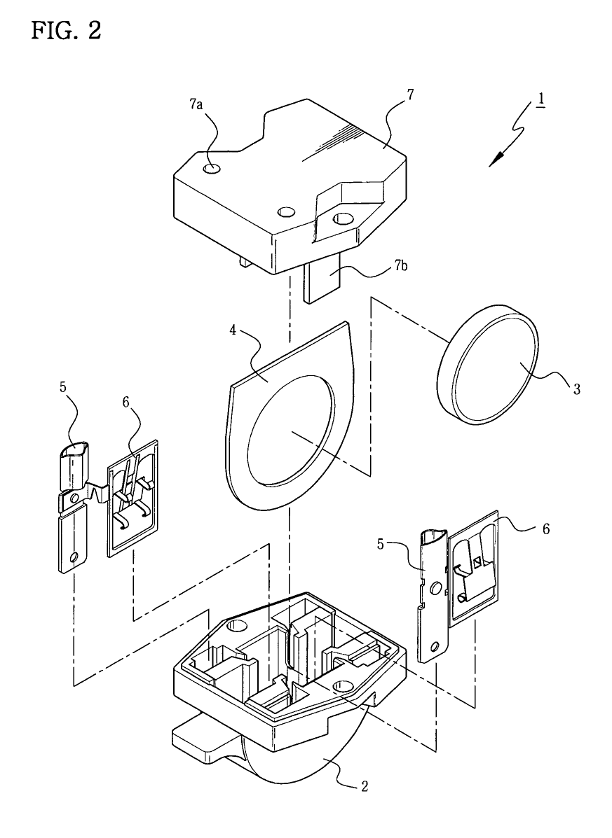

Before the construction of the present invention is described in detail, the construction of a PTC thermistor shown in FIGS. 1 and 2 is roughly described first. The PTC thermistor 1 includes a casing 2, a PTC element 3, an insulation holder 4, two conductive tap terminals 5, two spring terminals 6, and a cap 7. The casing 2 is made of a heat-resistant, insulating, nonflammable material. The PTC element 3 includes electrodes formed by coating both side surfaces of a coin-shaped body formed of barium titanate ceramic as a chief ingredient with a conducting material, such as silver. The insulation holder 4 fixedly holds the PTC element 3 so that the PTC element 3 is stably accommodated in the inner space of the casing 2. The pair of conductive tap terminals 5 is accommodated in the casing 2. The spring terminals 6 are each connected to the tap terminals 5, and each bent oppositely and each brought into contact with the electrodes of the PTC element 3 with the PTC element 3 being disposed therebetween. The cap 7 is provided with holes 7a formed at positions brought into contact with the tap terminals 5, and two insulation walls 7b extended from the bottom of the cap 7.

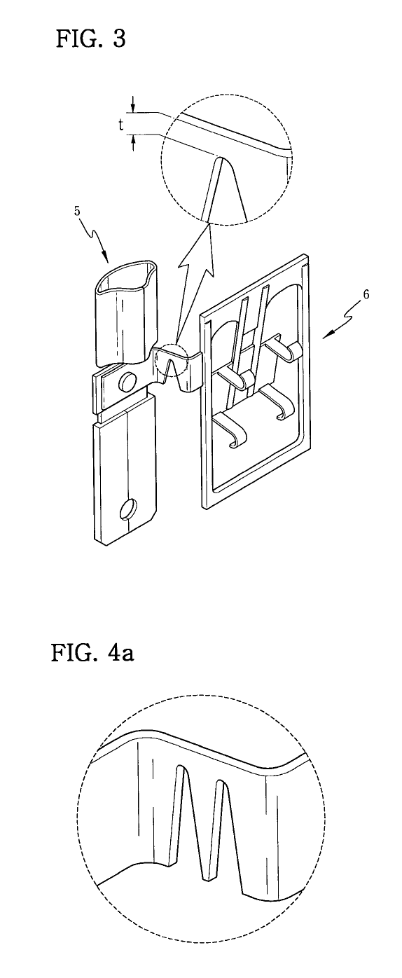

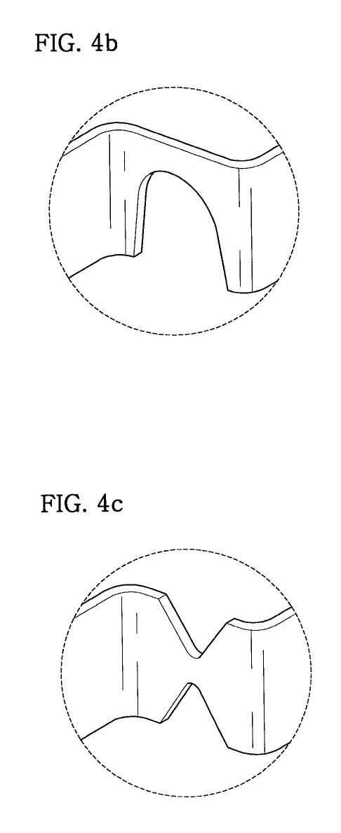

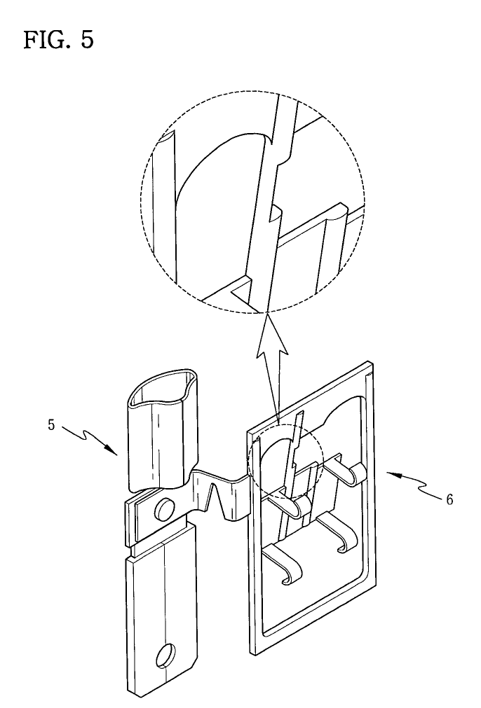

That is, as shown in FIGS. 3 to 5, in the PTC thermistor 1 of the present invention constructed as described above, a weak portion is formed in a portion of each of the spring terminals 6 connected to the tap terminals 5 so that the weak portion is connected to the PTC element 3 to allow a current to be applied to the PTC element 3, and functions as a fuse that will be cut off at the time of the inflow of an overcurrent.

The weak portion formed in the portion of the spring terminal 6 is integrated with the spring terminal 6 using the same material as that of the spring terminal 6.

Additionally, the weak portion formed in the portion of the spring terminal 6 may be formed at one or more positions.

The weak portion may not be formed on the spring terminal 6, but on each of the tap terminals 5.

The weak portion is defined by one of angled and rounded notches.

Additionally, the weak portion is formed so that one edge is made weak by cutting out the other edge, or a center portion is made weak by cutting out both edges.

The weak portion may be formed in another portion of the spring terminal 6 or tap terminal 5 where a forming process can be easily performed.

The weak portion is formed to have a size t ranging from 0.1 to 0.8 mm so as to act as a fuse and allow the current to flow therethrough without hindrance.

Meanwhile, the present invention may be variously modified and may be implemented in various forms.

The present invention should not be limited to a specific form mentioned in the above descriptions, rather, the present invention includes various modifications, additions and substitutions without departing from the scope and spirit of the invention as disclosed in the accompanying claims.

In the PTC thermistor 1 constructed as described above, the spring terminals 6 mechanically connected to the conductive tap terminals 5 are seated in the casing 2 made of an nonflammable insulating material, and the PTC element 3 fitted into the insulation holder 4 is inserted between the spring terminals 6 accommodated in the casing 2.

In this case, when the casing 2 is covered with the cap 7, the spring terminals 6 are pushed into the PTC thermistor 1 by the wedge portion of the cap 7, the lower portions of the tap terminals 5 connected to the spring terminals 6 are protruded outside the casing 2, and the contacts of the spring terminals 6 are mechanically and electrically connected to both side surfaces of the PTC element 3 by such an assembly process.

A more detailed description of the assembly process of the PTC thermistor 1 will be omitted below because such a process is usually performed in the prior art.

When an external current flows in the lower portions of tap terminals 5 protruded outside the casing 2 and connected to the outside after the assembly process has been completed, the current flows in tap terminals 5 and the spring terminals 6 mechanically and electrically connected to the tap terminals 5 and the current flowing in the spring terminals 6 directly flows into the PTC element 3, thus generating heat in the PTC thermistor 1.

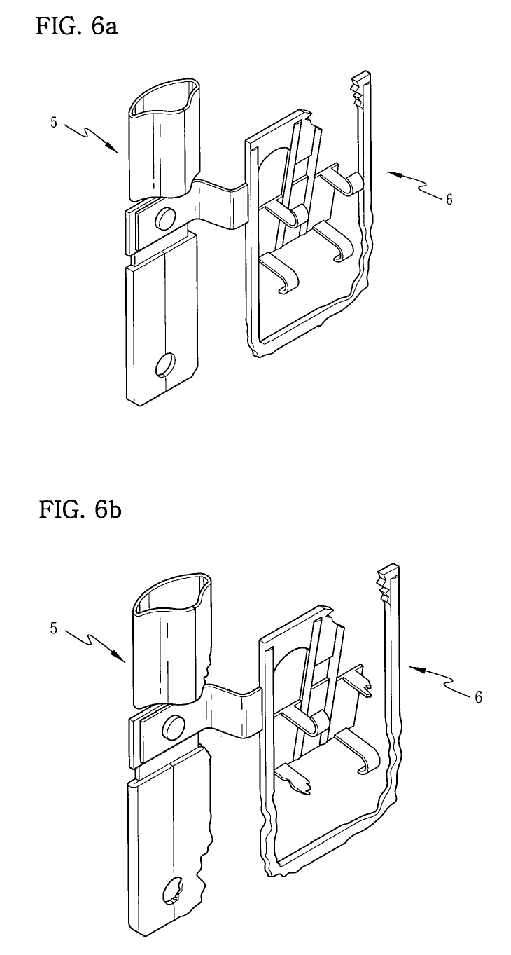

In the PTC thermistor 1, if a normal operating current flows in the PTC thermistor 1, a stable current flows in the weak portion. In contrast, if the PTC element 3 is broken by the thermal stress of the PTC element 3, or an overcurrent caused by an external abnormal power source flows in the PTC thermistor 1, continuous breakage, such as second and third breakage, caused by the breakage of the PTC element 3 is generated (see FIGS. 6A and 6B), so that contaminants or a fire are produced by the continuous breakage of the PTC element 3.

In the PTC thermistor 1 according to the present invention that is proposed to solve those problems, the weak portion is formed in the portion of each of the spring terminals 6 to function as a fuse that is cut off at the time when an abnormal phenomenon, such as the inflow of an overcurrent, occurs in the state that the spring terminals 6 mechanically connected to the tap terminals 5 connected to the outside are mechanically and electrically connected to the PTC element 3.

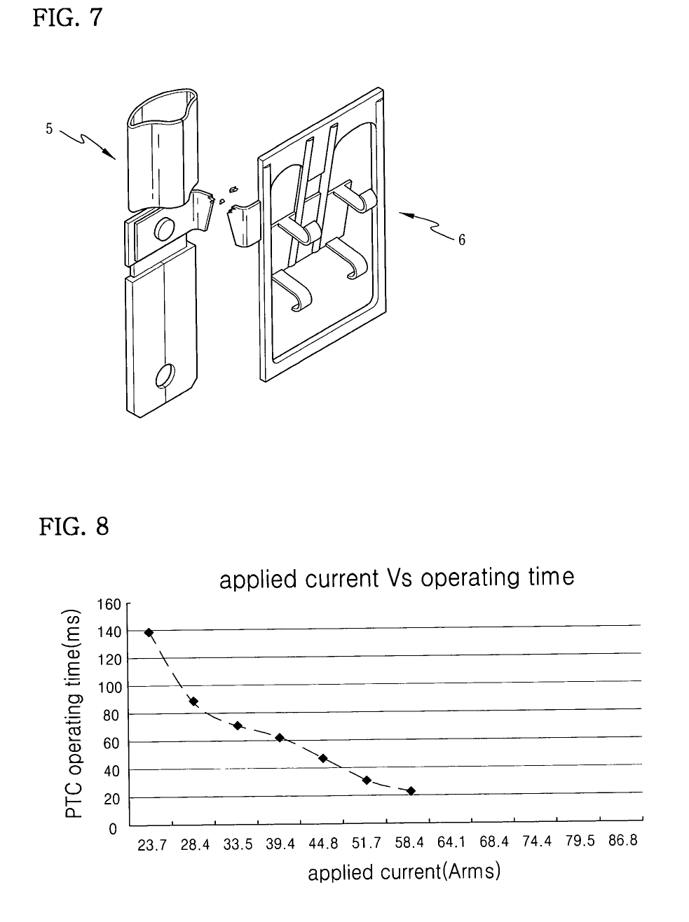

If a normal operating current flows in the PTC thermistor 1, a current stably flows in the weak portion formed in each of the spring terminals 6. In contrast, if the PTC element 3 is broken by the thermal stress of the PTC element 3, or an overcurrent caused by outside abnormal power flows in the PTC thermistor 1, the PTC element 3 undergoes an electrical shock, and at this time, and the weak portion is cut off while acting as a fuse if a current in excess of an allowable current flows in the weak portion (see FIG. 7).

Accordingly, if the weak portion is cut off, a short-circuit overcurrent generated at the time of the breakage of the PTC element 3 or an overcurrent flowing in the PTC thermistor 1 from the outside is open in an electric circuit, and, therefore, a current does not flow in the thermistor 1 and the continuous breakage of the PTC element 3 is not generated, thus preventing the generation of contaminants or a fire.

For other embodiments of the present invention, the weak portion formed in the portion of each the spring terminals 6 are integrated with the spring terminals 6 using the same material as those of the spring terminals 6. If necessary, the weak portion is formed at two or more positions in each of the spring terminals 6.

Additionally, even though the weak portion may not be formed on each of the spring terminals 6 but on each of the tap terminals 6, the same effect may be obtained.

The weak portion is defined by an angled or a rounded notch depending upon a process of forming the spring terminals 6 and the tap terminals 5. Additionally, the weak portion is formed so that one edge is made weak by cutting out the other edge or a center portion is made weak by cutting out both edges. The weak portion may not be formed in a portion where the spring terminals 6 and the tap terminals 5 are mechanically and electrically connected to each other, but may be formed in a portion of each of the spring terminals 6 or the tap terminals 5 where a forming process is easily performed.

If the size t of the weak portion formed as described above is formed to be in the range of 0.1 mm˜0.8 mm, a normal operational current can be applied through the weak portion while the weak portion can be allowed to function as a fuse.

If the size t of the weak portion is less than 0.1 mm, there occurs a problem in that the weak portion is cut off in the case where the normal current is applied. In contrast, if the size t of the weak portion is greater than 0.8 mm, the operating time of the weak portion is delayed, so that continuous breakage, such as second and third breakage, is generated by an overcurrent. A detailed description of this will be made below.

The spring terminals 6 are generally made of stainless steel, but may also be made of phosphor bronze or some other copper-based material according to embodiments of the present invention.

To test the performance of a product according to the present invention, products manufactured based on the prior art and the present invention were compared to each other through tests.

First, it is confirmed whether the weak portion implemented according to the present invention is cut off while acting as a fuse in the case where the PTC element 3 is broken. When PTC elements are broken by an artificial manipulation, the product of the present invention is compared with the product of the prior art.

For this purpose, PTC elements are made broken through artificial manipulation by applying an electric field to the PTC thermistors and allowing an excessive current to flow in the PTC thermistors using a variable power supply so as to examine the forms and patterns of breakage at the time of the breakage of the PTC elements. As a result, it can be appreciated that the tap terminals and spring terminals of the product of the prior art are electrically connected to each other at the time of a first breakage in the product of the prior art, so that second and third breakage continuously occurs (see FIGS. 6A and 6B). In contrast, it can be appreciated that the weak portion of the product of the present invention is cut off because the weak portion cannot endure the excessive current at the time of a first breakage and is electrically open, and the supply of power is automatically stopped (see FIG. 7).

To test current capacity of the weak portion of the PTC thermistor, the operating times of the weak portion acting as a fuse, that is, the times required for the weak portion to be cut off with respect to each of applied currents, were measured when currents ranging from a low current to a high current were applied to both ends of the weak portion using a 150 A ammeter.

The results of the measurements are shown in the following Table 1.

TABLE 1

| | Applied current (A) | | | | | | |
|---|---|---|---|---|---|---|---|
| | 10 | 15 | 18 | 20 | 21 | 22 | 25 |
| Operating time (sec) | 5 | 5 | 5 | 0.7˜0.8 | 0.6˜0.7 | 0.3˜0.4 | 0.2˜0.3 |

Additionally, the operating time of the PTC element 3 was measured using a power supply and an oscilloscope at the time when an overcurrent was flowing in the PTC thermistor 1 due to an initial resistance value of the PTC element 3 under normal conditions. The results of the measurements are shown in the following Table 2.

TABLE 2

| | Applied voltage (V) | | | | | | |
|---|---|---|---|---|---|---|---|
| | 120 | 150 | 180 | 210 | 240 | 270 | 300 |
| Total | 4.9 | 5 | 5 | 3.9 | 5 | 5.1 | 4.9 |
| resistance | | | | | | | |
| (Ω) | | | | | | | |
| Imax (p-p) | 67.0 | 80.4 | 94.9 | 111.4 | 126.8 | 146.4 | 165.0 |
| Imax (rms) | 23.70 | 28.44 | 33.55 | 39.40 | 44.85 | 51.77 | 58.35 |
| Operating | 139 | 89 | 71 | 62 | 47 | 31 | 23 |
| time (ms) | | | | | | | |

As shown in Table 2, it can be appreciated that a high current generated at the time of the breakage of the PTC element 3 is at least 100˜120 A at that instant.

Additionally, there is shown the determination of whether the weak portion acting as a fuse is operated according to the current flow in the following Table 3.

TABLE 3

| | Applied voltage (V) | | | | |
|---|---|---|---|---|---|
| | 250 | 270 | 290 | 310 | 330 |
| Resistance (average) | 3.9 | 3.8 | 3.9 | 3.9 | 3.8 |
| Current (theoretical value) | 64.10 | 68.42 | 74.36 | 79.49 | 86.84 |
| Operation state | X | X | X | X | X |

As shown in Table 3, it can be appreciated that the PTC element 3 is not operated by the application of currents as the result of examining the operation of the weak portion acting as a fuse after the currents flow into the PTC thermistor 1.

Additionally, Table 4 shows the relation between an applied current and the operating time of the PTC element 3, and the relation is easily confirmed through the graph of FIG. 8

TABLE 4

| | Operating time (ms) | | | | | | | | | | | |
|---|---|---|---|---|---|---|---|---|---|---|---|---|
| | 139 | 89 | 71 | 62 | 47 | 31 | 23 | | | | | |
| Applied | 23.7 | 28.4 | 33.5 | 39.4 | 44.8 | 51.7 | 58.4 | 64.1 | 68.4 | 74.4 | 79.5 | 86.8 |
| current | | | | | | | | | | | | |
| (Arms) | | | | | | | | | | | | |
| Current | | 4.7 | 5.1 | 5.9 | 5.4 | 6.9 | 6.7 | 5.7 | 4.3 | 6.0 | 5.1 | 7.3 |
| difference | | | | | | | | | | | | |

As shown in Table 4, it is appreciated that there is shown an inverse proportion relation in which the operating time of the PTC element 3 is gradually decreased as the applied current is gradually increased.

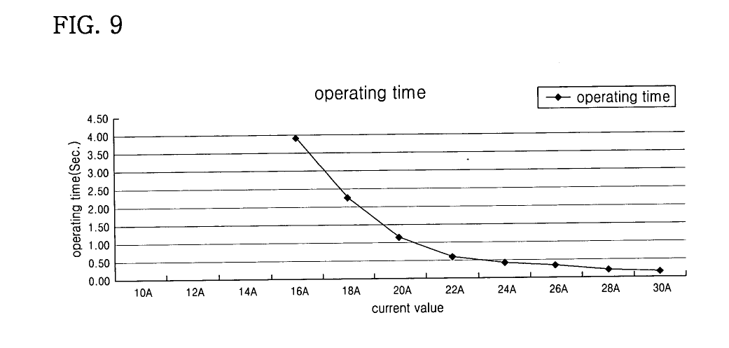

Meanwhile, Table 5 and the graph of FIG. 9 are used to confirm whether the weak portion acting as a fuse is cut off during the operating time of the PTC element when a normal current flows in the PTC thermistor 1, that is, an excessive current such as a surge current does not flow in the PTC thermistor 1 or the breakage of the PTC element is not generated, or confirm how fast the weak portion is cut off when an overcurrent flows in the PTC thermistor 1, that is, the surge current flows in the PTC thermistor 1 or the breakage of the PTC element 3 is generated. For this purpose, there are shown the results of measurements of the times at which the weak portion is cut off with respect to the values of currents after an ammeter is connected to both ends of the spring and tap terminals and the currents are applied using the 150 A ammeter.

TABLE 5

| | 1 | 2 | 3 | 4 | 5 | 6 | 7 | 8 | 9 | 10 | Max. | Min. | Avg. |
|---|---|---|---|---|---|---|---|---|---|---|---|---|---|
| 10A | More than 5 seconds | | | | | | | | | | | | |
| 12A | More than 5 seconds | | | | | | | | | | | | |
| 14A | More than 5 seconds | | | | | | | | | | | | |
| 18 A | 1.83 | 3.25 | 2.00 | 2.07 | 3.92 | 1.69 | 1.81 | 1.80 | 2.12 | 1.95 | 3.92 | 1.69 | 2.24 |
| 20 A | 2.30 | 0.85 | 0.83 | 0.84 | 1.23 | 0.84 | 0.95 | 1.22 | 0.96 | 1.14 | 2.30 | 0.83 | 1.12 |
| 22 A | 0.61 | 0.53 | 0.47 | 0.49 | 0.43 | 0.55 | 0.61 | 0.56 | 0.77 | 0.69 | 0.77 | 0.43 | 0.57 |
| 24 A | 0.29 | 0.37 | 0.40 | 0.33 | 0.76 | 0.32 | 0.29 | 0.34 | 0.41 | 0.29 | 0.76 | 0.29 | 0.38 |
| 26 A | 0.23 | 0.10 | 0.67 | 0.24 | 0.58 | 0.21 | 0.31 | 0.22 | 0.18 | 0.23 | 0.67 | 0.10 | 0.30 |
| 28 A | 0.17 | 0.16 | 0.15 | 0.20 | 0.18 | 0.16 | 0.19 | 0.18 | 0.20 | 0.19 | 0.20 | 0.15 | 0.18 |
| 30 A | 0.09 | 0.12 | 0.10 | 0.09 | 0.12 | 0.11 | 0.13 | 0.10 | 0.11 | 0.11 | 0.13 | 0.09 | 0.11 |

As shown in Table 5, the time at which the weak portion was cut off for each of the current values was measured ten times, and, then, a maximum value, a minimum value and an average value were obtained from the measurement results.

The measurements for the weak portion shown in Tables 1 to 5 were performed using the weak portion of a size t in the range of 0.3 mm˜0.4 mm.

The following Table 6 shows the relation between a cut-off time and an inflow current in the case where the size t of the weak portion is 0.3 mm, and, additionally, shows the relation between a cut-off time and an inflow currents in the case where the size t of the weak portion is less than 0.1 mm and greater than 0.8 mm.

TABLE 6

| | PTC | For size of weak portion | | | |
|---|---|---|---|---|---|
| Inflow | operating | More than | | | Less than |
| current | time | 0.8 mm | | 0.3 mm | 0.1 mm |
| 18A | | More than | | 2.24 seconds | 0.72 seconds |
| | | 5 seconds | | | |
| 20A | | More than | | 1.12 seconds | 0.32 seconds |
| | | 5 seconds | | | |
| 22A | 0.14 seconds | More than | | 0.57 seconds | 0.12 seconds |
| | | 5 seconds | | | |
| 24A | | 2.2 | seconds | 0.38 seconds | 0.10 seconds |
| 26A | 0.09 seconds | 1.56 | seconds | 0.30 seconds | 0.08 seconds |
| 28A | | 1.07 | seconds | 0.18 seconds | 0.07 seconds |
| 30A | 0.07 seconds | 0.67 | seconds | 0.11 seconds | 0.06 seconds |

As shown in Table 6, if the size t of the weak portion is greater than 0.8 mm, that is, if current capacity is large, the weak portion does not have a cut-off problem or other troubles at the time of the inflow of a normal current, but the cut-off time of the weak portion becomes longer when an overcurrent flows in the PTC thermistor 1, so that the protection of the breakage of the PTC element is delayed, which results in explosion. Additionally, if the size t of the weak portion is less than 0.1 mm, that is, if current capacity is small, the weak portion is cut off rapidly compared to the operating time of the PTC element 3 at the time of the inflow of a high current in a normal circuit, so that troubles may be generated in normal conditions.

Accordingly, the operating time at which the weak portion is cut off, that is, the current capacity, is faster than the operating time of the PTC element 3 irrespective of the inflow current, so that it is desirable that the size t of the weak portion is in the range of 0.1 mm˜0.8 mm.

Accordingly, in the PTC thermistor 1 of the present invention, when the normal current flows in the PTC thermistor 1, the PTC element 3 is operated and the weak portion acting as a fuse is not cut off. In contrast, when the high current flows in the PTC thermistor 1, the weak portion acting as a fuse is cut off within a certain time, so that a total circuit is open, and then no more breakage of the PTC element 3 occurs.

As described above, the present invention provides a PTC thermistor having a safety structure for preventing continuous breakage, in which an electrically weak portion of a size in the range of 0.1 mm˜0.8 mm is formed in a portion of each of the spring terminals connecting the tap terminals to the PTC element. Therefore, a stable current flows in the weak portion if a normal operating current flows in the PTC thermistor 1, whereas the weak portion is cut off while acting as a fuse because a current in excess of an allowable current is generated in the weak portion if the PTC element is broken by the thermal stress of the PTC element or an overcurrent caused by external abnormal power. Accordingly, the continuous breakage of the PTC element is no longer generated by preventing the generation of current flow because a short-circuit overcurrent generated at the time of the breakage of the PTC element or an overcurrent flowing into the PTC thermistor from the outside is interrupted in an electric circuit due to the cutting off of the weak portion. Therefore, the generation of contaminants or a fire resulting from the continuous breakage of the PTC element is prevented, and, therefore, the total efficiency of a product is improved and the reliability of the product is maximized.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A Positive Temperature Coefficient (PTC) thermistor having a safety structure for preventing continuous breakage, comprising:
a casing made of a heat-resistant, insulating and nonflammable material;
a PTC element provided with electrodes formed by coating both sides of a coin-shaped body formed of barium titanate ceramic as a chief ingredient with a conducting material, such as silver;
an insulation holder adapted to fixedly hold the PTC element so that the PTC element is stably accommodated in an inner space of the casing;
two conductive tap terminals accommodated in the casing;
two spring terminals each connected to the tap terminals, each bent symmetrically and oppositely and each brought into contact with the electrodes of the PTC element with the PTC element being disposed therebetween; and
a cap provided with holes formed at positions brought into contact with the tap terminals, and two insulation walls extended from a bottom of the cap;
wherein a weak portion is formed in a portion of each of the spring terminals connected to the tap terminals so as both to allow a current to be applied to the PTC element while connecting with the PTC element and to act as a fuse that is cut off at a time of inflow of an overcurrent.

2. The PTC thermistor as set forth in claim 1, wherein the weak portion formed in the portion of each of the spring terminals is integrated with the spring terminals using a same material as the spring terminals.

3. The PTC thermistor as set forth in claim 1 or 2, wherein the weak portion formed in the portion of each of the spring terminals is formed at one or more locations.

4. The PTC thermistor as set forth in any of claims 1 to 3, wherein the weak portion is not formed in each of the spring terminals, but formed in each of the tap terminals.

5. The PTC thermistor as set forth in any of claims 1 to 4, wherein the weak portion is defined by an angled or a rounded notch.

6. The PTC thermistor as set forth in any of claims 1 to 5, wherein the weak portion is formed so that a first edge is made weak by cutting out a second edge, or a center portion is made weak by cutting out both edges.

7. The PTC thermistor as set forth in any of claims 1 to 6, wherein the weak portion is formed in another portion of each of the spring terminals or the tap terminals where a forming process is easily performed.

8. The PTC thermistor as set forth in any of claims 1 to 7, wherein the weak portion is formed to have a size t ranging from 0.1 mm to 0.8 mm so as to act as a fuse and allow the current to flow therethrough without hindrance.
